(19) United States
(12) Patent Application Publication
(10) Pub. No.: US 2009/0119717 A1
(43) Pub. Date: May 7, 2009

(54) METHOD AND SYSTEM FOR UTILIZING VIDEO CONTENT TO OBTAIN TEXT KEYWORDS OR PHRASES FOR PROVIDING CONTENT RELATED TO LINKS TO NETWORK-BASED RESOURCES

(75) Inventors: Philips Steven Newton, Eindhoven (NL); Declan Patrick Kelly, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 10/545,645

(22) PCT Filed: Dec. 4, 2003
(86) PCT No.: PCT/IB2003/005662

§ 371 Date: Jan. 5, 2009

Related U.S. Application Data
(60) Provisional application No. 60/432,542, filed on Dec. 11, 2002.

(51) Int. Cl. H04N 5/445; G06F 17/30

(52) U.S. Cl. 725/59; 707/5; 707/E17.014

(57) ABSTRACT

A method and system is provided for utilizing video content to obtain text keywords or phrases for providing content related links from network-based resources for information related to the video content topics in a video presentation includes: an extractor configured to extract video content, such as the beginning or end credits, from a video presentation, such as a television movie or program; a recognizer, configured to produce a textual representation of text in the video content; a parser, configured to parse the textual representation of the video content for topic language; and a search function using the topic language from the parser as a search criteria, wherein search function searches for WEB sites having information matching the topic language, returns URLs for Web sites found, and associates the URLs with the topic language, and an interface for providing the user the ability to view the information found for the topic language.

The present invention relates generally to video signal processing, and more particularly to methods and apparatus for searching out and obtaining interactive links to universal resource locators (URL's) for presentation in an interactive video program, based on extracting keywords or phrases from the video content.

In recent years there have been concerted efforts to integrate various systems to provide enhanced information delivery and entertainment systems. For example, developers are introducing integrated systems combining TVs with computer subsystems, so a TV may be used as a WEB browser, or a PC may be used for enhanced TV viewing.

One method for accessing information available on the Internet consists of a basic television set for displaying Internet information and a “set-top box” for accessing selected information from the Internet. The set-top box provides the accessed information to the corresponding television set for display. A set-top box is typically a relatively small and economical device that is located near the television set to serve as an efficient interface with the Internet in consumer home-use applications.

In such a set-top box system the user controls access to Internet data pages by the use of a remote control and views the data pages on the television (TV). The data pages are hypertext pages (web pages) retrieved from the Internet. The set-top box connects to the Internet via a communication line. When the user of the system manipulates the remote control to access a particular Internet page on a particular server, and the set-top box converts the user input into an address called a Uniform Resource Locator (URL). Then the URL causes the specified remote server to respond and transmit the specified Internet page (web page) via the Internet to the set-top box. The set-top box then converts this digital data into an analog format suitable for display on the attached TV screen. The selected Internet pages may contain a variety of textual and graphics information in various appropriate formats.

After accessing the selected Internet pages, the set-top box then provides the accessed pages to a television for display to system viewers. A remote control is used, where a system user may input various types of information to control the operation of set-top box and television. However, the remote control typically requires particular programming or special input keys for such interactive applications.

Still further, viewing and manipulating the stored pages of Internet information using this method is a relatively laborious and cumbersome process. During the TV broadcast, if the system user wishes to retrieve some information concerning the TV broadcast (for example, the background of a particular director or actor), the user must record the particular topic and search for a URL address. In addition, the user must either interrupt his or her viewing of the TV broadcast to perform an Internet search or the system user must wait until a convenient break in the TV broadcast to perform the Internet search.

The ability to access additional information related to topics in a video presentation, for example the Internet, while simultaneously watching a television program would provide a more efficient and effective method for utilizing Internet information. Thus, for the foregoing reasons, an improved system and method are needed for a user to obtain additional information related to topics in a video presentation without significant interruption of the viewing of the television/video programming, using a network-based resource such as the Internet.

The invention provides a method and system for utilizing video content in a video presentation (such as a movie film's credits or a video segment containing text such as a sign, letter or the like) to obtain text keywords or phrases for providing content related links (e.g. universal resource locators, URL's) from network-based resources (e.g. the Internet) for information corresponding to the topics of the video content.

In accordance with the invention, a system for utilizing video content to obtain text keywords or phrases for providing content related links from network-based resources for information related to the video content topics in a video presentation includes: an extractor configured to extract video content, such as the beginning or end credits, from a video presentation, such as a television movie or program; a recognizer, configured to produce a textual representation of text in the video content; a parser, configured to parse the textual representation of the video content for topic language; and a search function using the topic language from the parser as a search criteria, wherein search function searches for WEB sites having information matching the topic language, returns URLs for Web sites found, and associates the URLs with the topic language; and an interface for providing the user the ability to view the information found for the topic language.

In one embodiment a hyperlink generator is provided for creating hyperlinks to the information found and overlaying the hyperlinks over the topic language, for example credits of a movie. By selecting the credits (or the overlaid hyperlinks) the user is redirected to a web site that gives more information on the “credit” item selected.

Other features of the present invention will become apparent from the following detailed description considered in conjunction with the accompanying drawings.

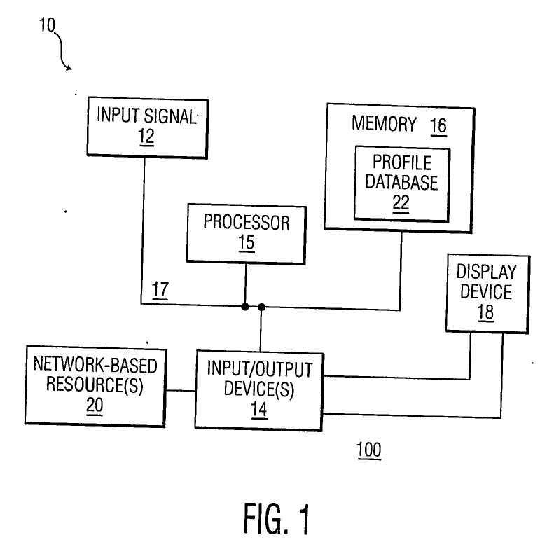

FIG. 1 is a block diagram of a video processing system in which the invention may be implemented.

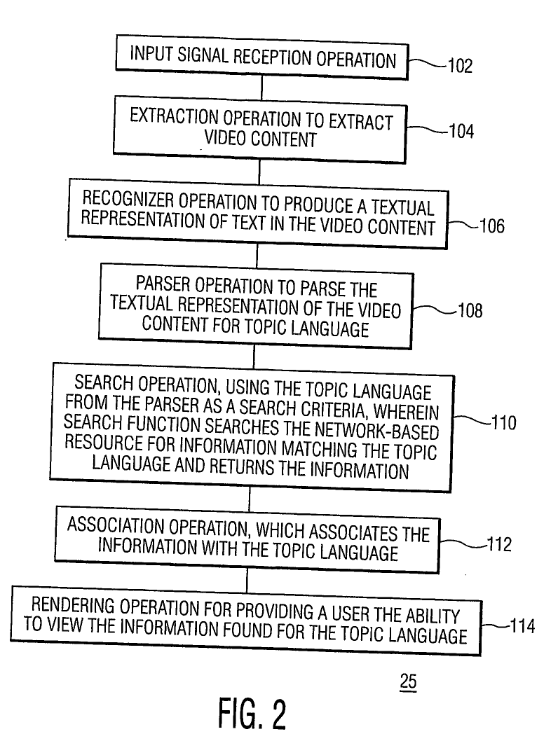

FIG. 2 is a diagram of a process for utilizing video content to obtain text keywords or phrases for providing content related links from network-based resources for information related to the video content topics in a video presentation in accordance with an illustrative embodiment of the invention that may be implemented in the video processing system of FIG. 1.

It is to be understood that these drawings are solely for purposes of illustrating the concepts of the invention and are not intended as a definition of the limits of the invention. It will be appreciated that the same reference numerals, possibly supplemented with reference characters where appropriate, have been used throughout to identify corresponding parts.

FIG. 1 shows a video processing system 10 in which video content is utilized to obtain text keywords or phrases for providing content related links from network-based resources for information related to the video content topics in a video presentation in accordance with the present invention may be implemented. As will be described in greater detail below, the system 10 may represent or incorporate a television, a set-top box, a desktop, laptop or palmtop computer, a personal digital assistant (PDA), a video storage device such as a videocassette recorder (VCR), a digital video recorder (DVR), an optical disk, magnetic disk or solid state based recorder such as a TiVO or ReplayTV device, etc., as well as portions or combinations of these and other devices.

The system 10 includes one or more video sources 12, one or more input/output devices 14, a processor 15, a memory 16 and one or more network-based resources 20. The video source(s) 12 may represent, e.g., a television receiver, a VCR or other video storage device, or any other type of video source. The source(s) 12 may alternatively represent one or more service provider network connections for receiving video from a television network, server or servers over, e.g., a global computer communications network such as the Internet, a wide area network, a metropolitan area network, a local area network, a terrestrial broadcast system, a cable network, a satellite network, a wireless network, or a telephone network, as well as portions or combinations of these and other types of networks. The video sources provide a free or commercial video signal that contains content a user wishes to view such as a theatrical presentation, programs, shows, pay-per-view movies and the like. The network-based resource(s) 20 represent one or more service provider network connections for receiving information, such as URLs, from a global computer communications network such as the Internet, a wide area network, a metropolitan area network, a local area network, a terrestrial broadcast system, a cable network, a satellite network, a wireless network, or a telephone network, as well as portions or combinations of these and other types of networks.

The input/output device(s) 14, processor 15, and memory 16 communicate over a communication medium 17. The communication medium 17 may represent, e.g., a bus, a communication network, one or more internal connections of a circuit, circuit card or other device, as well as portions and combinations of these and other communication media. Input video from the source(s) 12 and the network-based resource(s) 20 are processed, e.g., in accordance with one or more software programs stored in memory 16 and executed by processor 15, or using dedicated hardware or firmware configured to operate in like manner, in order to generate output video, described further below, which is supplied to a display device 18, which may be, e.g., a television display, a computer monitor, etc.

Processor 15 is advantageously configured to (1) extract video content, such as the beginning or end credits, from a video presentation, such as a television movie or program, (2) produce a textual representation of text in the video content, (3) parse the textual representation of the video content for topic language, (4) perform a search function using the topic language from the parsed textual representation as a search criteria, wherein search function searches for WEB sites having information matching the topic language, returns URLs for Web sites found, and (5) associates the URLs with the topic language.

As shown in FIG. 1, a profile database 22 may be used to store user specific data. It is noted that the profile database 116 may be integrated with the Memory 16. The processor 15 processes the document from the information from the network-based resource(s) 20 and accesses an appropriate profile from the profile database 22. The profiles represent information associated with a particular user for the system. One or more profiles may be associated with a particular system for different users. Each profile includes information related to previous information requests. They may also contain user preferences as provided by each user, regarding programs, movies, and the like as determined by the processor 15 using historical information indicative of previous information requests.

It should be understood that the particular configuration of system 10 as shown in FIG. 1 is by way of example only. Those skilled in the art will recognize that the invention can be implemented using a wide variety of alternative system configurations.

FIG. 2 shows a diagram of an example process 100 for utilizing video content in a video presentation, such as a movie film's credits, to obtain text keywords or phrases for providing content related links (e.g. universal resource locators, URL's) from network-based resources (e.g. the Internet) for information corresponding to the topics of the video content in accordance with an illustrative embodiment of the invention.

The process 100 in this embodiment includes an input signal reception operation 102, such as a television movie or program, an extraction operation 104 to extract video content, such as the beginning or end credits, from the input signal, such as a video/audio signal, a recognizer operation 106 to produce a textual representation of text in the video content, a parser operation 108 to parse the textual representation of the video content for topic language; and a search operation 110, using the topic language from the parser as a search criteria, wherein search function searches the network-based resource, such as WEB sites, for information matching the topic language and returns the information, such as URLs for Web sites found, an association operation 112, which associates the information with the topic language; and a rendering operation 114 for providing a user the ability to view the information found for the topic language.

A service provider would offer this process for a fee. The fee may be charged using a monthly subscription or on a per program basis, which is accounted for in system 10. Thus, enabling an additional or alternate source of revenue to the service providers.

Alternatively, the network-base resource owner, e.g. the website owner, can pay a fee for the system 10 to use their resources, e.g. direct user to their websites, thereby increasing traffic thereto.

In the extraction operation 104, input video signal received in system 10 is processed to extract particular video segments. Particularly advantageous is the extraction of video credit information from the beginning or ending of a video presentation. Portions of the input video signal, such as the beginning and/or ending credit video portions, may be cached or otherwise stored in an appropriate storage device, e.g., a hard disk or other storage device associated with memory 16, or other element of system 10. For example, using a conventional hard disk recording device.

In the recognizer operation 106, which produces a textual representation of text in the video content, it is particularly advantageous to use Object Character Recognition (OCR). In general, OCR includes an image scanner to optically capture text images to be recognized. The text images are processed in three steps: (1) document analysis (extracting individual character images), (2) recognizing these images (based on shape), and (3) contextual processing (either to correct misclassifications made by the recognition algorithm or to limit recognition choices). Alternatively, other conventional methods video character recognition may be used.

Thereafter, the parser operation 108 parses the textual representation of the video content for topic language. For example, the name of an actor. The search operation 110 uses the topic language from the parser operation as a search criteria, wherein search function searches the network-based resource, such as WEB sites, for information matching the topic language and returns the information, such as URLs for Web sites found.

The software design for the communication layers/stacks of the system 10 may include: Physical and data link layers: Ethernet, Bluetooth, 1394, or other similar protocols; Network and transport layers: IP and TCP protocols; HTTP protocol: Post feature only; Simple Object Access Protocol (SOAP): read/write capabilities only; XML parser using Document Object Model (DOM) or Simple API for XML (SAX) interfaces. Preferably a micro XML parser (less than 40 KB in size) is used as described in U.S. patent application Ser. No. 09/725,970, filed Nov. 29, 2000, incorporated herein by reference; Memory or serial interface to tag reader.

SOAP is a protocol for exchanging information in a distributed, decentralized environment. SOAP is an XML based protocol consisting of: an envelope which defines a means for describing what a message contains and how it is to be processed, encoding rules for expressing application-defined datatypes, and a convention for representing remote procedure calls and responses. SOAP messages are typically one-way transmissions from a sender to a receiver, but they can be combined to implement patterns such as request/response.

HTTP is a protocol with the lightness and speed necessary for a distributed collaborative hypermedia information system. It is a generic stateless object-oriented protocol, which may be used for many similar tasks such as name servers, and distributed object-oriented systems, by extending the commands, or “methods”, used. A feature of HTTP is the negotiation of data representation, allowing systems to be built independently of the development of new advanced representations.

In general, sending data over the Internet is typically performed using Transmission Control Protocol/Internet Protocol (TCP/IP).

The physical layer is concerned with the electrical, mechanical and timing aspects of signal transmission over a communication medium. The system 10 can include any one or more of a variety of well known layers such as modems, Ethernet, cellular and Bluetooth.

Returning now to FIG. 2, in the association operation 110 the received information is associated with the topic language. Lastly, in the rendering operation 112 the user is provided the ability to view the information found for the topic language. For example, interface to a display unit or monitor.

According to another aspect of the invention (not shown), the techniques can be implemented in a fully automatic manner such that the system modifies the video signal.

The video signal, for example, is re-formatted to include links in with the corresponding credit information of the video signal for a user to access. The links correspond to URL's found by the system 10 as well as those provided by a service provider.

Additionally, to increase the system performance in real-time applications, the system 10 can use the available Electronic Program Guide (EPG) data and the opening credits of a video presentation to perform a search in the background during the program and cache the relevant video segments. Moreover, the search can be limited to a restricted set of websites to improve the speed further.

The following merely illustrates the principles of the invention. It will thus be appreciated that those skilled in the art will be able to devise various arrangements which, although not explicitly described or shown herein, embody the principles of the invention and are included within its spirit and scope. Furthermore, all examples and conditional language recited herein are principally intended expressly to be only for pedagogical purposes to aid the reader in understanding the principles of the invention and the concepts contributed by the inventor(s) to furthering the art, and are to be construed as being without limitation to such specifically recited examples and conditions.

Thus, for example, it will be appreciated by those skilled in the art that the block diagrams herein represent conceptual views of illustrative circuitry embodying the principles of the invention. Similarly, it will be appreciated that any flow charts and the like represent various processes which may be substantially represented in computer readable medium and so executed by a computer or processor, whether or not such computer or processor is explicitly shown.

The functions of the various elements shown in the FIGS. 1 and 2, including functional blocks labeled as “processors” may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, read-only memory (ROM) for storing software, random access memory (RAM), and non-volatile storage. Other hardware, conventional and/or custom, may also be included. Their function may be carried out through the operation of program logic, through dedicated logic, through the interaction of program control and dedicated logic, or even manually, the particular technique being selectable by the implementor as more specifically understood from the context.

In the claims hereof any element expressed as a means for performing a specified function is intended to encompass any way of performing that function including, for example, a) a combination of circuit elements which performs that function or b) software in any form, including, therefore, firmware, microcode or the like, combined with appropriate circuitry for executing that software to perform the function. The invention as defined by such claims resides in the fact that the functionalities provided by the various recited means are combined and brought together in the manner which the claims call for. Applicant thus regards any means which can provide those functionalities as equivalent as those shown herein.

1. A method of doing business comprising the steps of:
extracting predetermined video segments from an input signal;
producing a textual representation of the video segments;
parsing the textual representation of the video segments for topic language;
searching a network-based resource using the topic language as a search criteria, wherein searching step searches for information matching the topic language;
associating the matching information with the topic language;
providing a user the ability to view the matching information found for the topic language; and
charging a fee to a user for displaying the matching information.

2. A method for providing a content related link from network-based resources for information related to a video content topic in a video presentation, the method comprising the steps of:
extracting video content from the video presentation;
recognizing the video content to produce a textual representation the video content;
parsing the textual representation of the video content for topic language;
searching the network-based resource using the topic language, wherein searching step determines a content related link having information matching the topic language; and
associating the content related link with the topic language.

3. The method as recited in claim 2 further comprising the step of allowing access to the content related link to a user using the associated topic language.

4. The method as recited in claim 2 further comprising the step of storing the video content or content related link.

5. The method as recited in claim 2 wherein the video content of a video presentation is selected from the group consisting of a beginning credit, end credit and a video segment containing text.

6. The method as recited in claim 2 wherein the content related link is a URL.

7. An apparatus for providing a content related link from network-based resources for information related to a video content topic in a video presentation, the apparatus comprising:
a processor for (1) extracting video content from the video presentation, (2) recognizing the video content to produce a textual representation the video content, (3) parsing the textual representation of the video content for topic language, (4) searching the network-based resource using the topic language, wherein searching step determines a content related link having information matching the topic language, and (5) associating the content related link with the topic language; and
a memory which enables storage of the content related-link.

8. The apparatus as recited in claim 7, wherein the processor is further configured to allow access to the content related link to a user using the associated topic language.

9. The apparatus as recited in claim 7, wherein the memory enables storage of the video content.

10. The apparatus as recited in claim 8, wherein the processor further includes accounting for user access of the content related link.

11. The apparatus as recited in claim 6, wherein the video content of a video presentation is selected from the group consisting of a beginning credit, end credit and a video segment containing text.

12. The apparatus as recited in claim 6, wherein the content related link is a URL.

13. The apparatus as recited in claim 8, further including a display which enables viewing information contained in the content related link.
